(19) United States
(12) Patent Application Publication
(10) Pub. No.: US 2005/0259751 A1
(43) Pub. Date: Nov. 24, 2005

(54) System and a method for controlling audio/video presentation on a sink device

(76) Inventors: Brad T. Howard, Lawrenceville, GA (US); Stephen A. Allinson, Langhorne, PA (US); Christopher S. Del Sordo, Souderton, PA (US); Christopher J. Stone, Newton, PA (US); Terry L. Ziegler, Lansdale, PA (US)

Correspondence Address: STEVEN L. NICHOLS;RADER, FISHMAN & GRAVER PLLC, 10653 S. RIVER FRONT PARKWAY, SUITE 150, SOUTH JORDAN, UT, 84095, US

(21) Appl. No.: 10/850,902

(22) Filed: May 21, 2004

(51) Int. Cl. H04N 11/04; H04N 7/12

(52) U.S. Cl. 375/240.26

(57) ABSTRACT

A method for encoding an audio/video (AV) program for muting on a sink device includes generating or recovering at least one digital transport stream having the AV program, augmenting the at least one digital transport stream with control information, the control information being configured to invoke a muting of at least one component of the AV program by the sink device, and transmitting the augmented digital transport stream over a digital link coupled to the sink device.

### FIELD

The present method and system relate to audio/visual systems. More particularly, the present method and system provide for controlling the display of audio/visual data over a digital link.

### BACKGROUND

Recently, high definition televisions (HDTVs) with digital interfaces, such as the IEEE 1394 bus interface, have appeared on the market. The IEEE 1394 bus (also referred to as FireWire, iLink, or DTV-Link) is a high-speed serial bus for transmitting digital data. In a typical configuration, a user employs an external tuning device, such as a set-top box (STB), to receive audio/video (AV) signals from a cable or a satellite operator, or from a terrestrial broadcast. The STB, or “source device”, tunes to a particular AV signal to receive an AV stream, which is coupled to the digital bus. For example, the AV stream may include compressed AV data in accordance with the MPEG (Moving Pictures Expert Group) standard and the source device may output an MPEG-2 transport stream to the digital bus. The receiving, or “sink device”, receives the AV stream over the digital bus, decodes the AV data therein, and displays the decoded AV data. By employing a digital bus, an AV system reduces or eliminates noise and other deleterious effects typically associated with analog transmission.

Use of an IEEE 1394 bus to transmit an AV stream between a source device and a sink device is in its infancy and there are several operational issues still to be resolved. One such issue deals with the muting of audio and/or video data from an MPEG transport stream. Traditional methods for muting an audio or video signal from a received MPEG transport stream that is to be transferred over an IEEE 1394 bus include modifying the MPEG transport stream based on the presentation state (i.e. mute state) settings at the source device. For example, if video is muted by the STB application, the video component is removed from the MPEG transport stream. Similarly, if audio is muted by the STB application, the audio component is removed from the MPEG transport stream. According to traditional methods, if both audio and video are muted, then the MPEG transport stream is simply not sent to the sink device. This “brute force” method for muting the audio and/or video signal transmitted from the source device yields a less than optimal user experience. For example, muting audio in the source device may result in video blinking when it is displayed by the sink device. Additionally, muting video in the source device may result in a freeze frame image rather than a mute to black. Similarly, muting both audio and video may be interpreted by the sink device as a loss of signal resulting in a blue screen, a loss of signal message, or another inappropriate indication to the user.

### SUMMARY

A method for encoding an audio/video (AV) program for muting on a sink device includes generating or recovering at least one digital transport stream having the AV program, augmenting the at least one digital transport stream with control information, the control information being configured to invoke a muting of at least one component of the AV program by the sink device, and transmitting the augmented digital transport stream over a digital link coupled to the sink device.

### BRIEF DESCRIPTION OF THE DRAWINGS

The accompanying drawings illustrate various embodiments of the present method and system and are a part of the specification. Together with the following description, the drawings demonstrate and explain the principles of the present method and system. The illustrated embodiments are examples of the present method and system and do not limit the scope thereof.

FIG. 1 is a block diagram illustrating an audio/video (AV) system, according to one exemplary embodiment.

FIG. 2 is a block diagram illustrating a stream encoder for use with an AV system such as that shown in FIG. 1, according to one exemplary embodiment.

FIG. 3 is a block diagram illustrating a stream decoder for use with an AV system such as that shown in FIG. 1, according to one exemplary embodiment.

FIG. 4 is a flow diagram illustrating a process for encoding an AV program for muting functions to be performed on a sink device, according to one exemplary embodiment.

FIG. 5 is a flow diagram illustrating a process for decoding one or more digital transport streams produced by the encoding process of FIG. 4, according to one exemplary embodiment.

FIG. 6 is a data flow diagram illustrating the encoding process of FIG. 4 for an AV program, according to one exemplary embodiment.

FIG. 7 is a presentation control descriptor, according to one exemplary embodiment.

FIG. 8 is a generic data structure that may be used for an AV command, according to one exemplary embodiment.

FIG. 9 is a command operational code (opcode) and operand definition chart, according to one exemplary embodiment.

Throughout the drawings, identical reference numbers designate similar, but not necessarily identical, elements.

### DETAILED DESCRIPTION

The present specification describes a method and a system for controlling the presentation properties of an MPEG transport stream by leveraging the extant presentation properties of a sink device. More specifically, the present method and system are configured to augment a digital transport stream with control information that causes the sink device to perform audio and/or video mute functions on the content of the transport stream using its own extant muting capabilities. Exemplary systems and structures will be described in further detail below.

In the present specification and in the appended claims, the term “transmitter” or “source device” is meant to be understood as any electrical component such as a set-top box that is configured to receive a signal from a head-end unit, a telestial source, or another signal source and subsequently tune, encode, and/or transmit that signal to any number of sink devices. A “set-top box” or an “STB” is meant to be understood broadly as any device that enables a television set to become a user interface to the Internet or enables an analog television set to receive and decode digital television (DTV) broadcasts. A “sink device,” as used in the present specification and appended claims, is meant to be understood as any display device or other receiver configured to receive a signal from a transmitter or source device through an IEEE 1394 bus connection including, but in no way limited to, a projector, a high-definition television, or digital video home system (VHS).

In the following description, for purposes of explanation, numerous specific details are set forth in order to provide a thorough understanding of the present method and system for controlling the presentation properties of an MPEG transport stream through a 1394 bus using the extant presentation properties of a sink device. It will be apparent, however, to one skilled in the art that the present method may be practiced without these specific details. Reference in the specification to “one embodiment” or “an embodiment” means that a particular feature, structure, or characteristic described in connection with the embodiment is included in at least one embodiment. The appearance of the phrase “in one embodiment” in various places in the specification are not necessarily all referring to the same embodiment.

A system and a method for controlling the presentation properties of an MPEG transport stream using the extant presentation properties of a sink device are described in detail below. While one or more aspects of the present system and method are described with respect to an MPEG (Moving Pictures Expert Group) transport carrying AV programs over an IEEE 1394 bus, the present system and method may be used with other types of digital transport streams comprising time-division multiplexed (TDM) or packet division multiplexed (PDM) data. In addition, the present system and method may be used with other types of digital buses, such as a universal serial bus (USB) and the like.

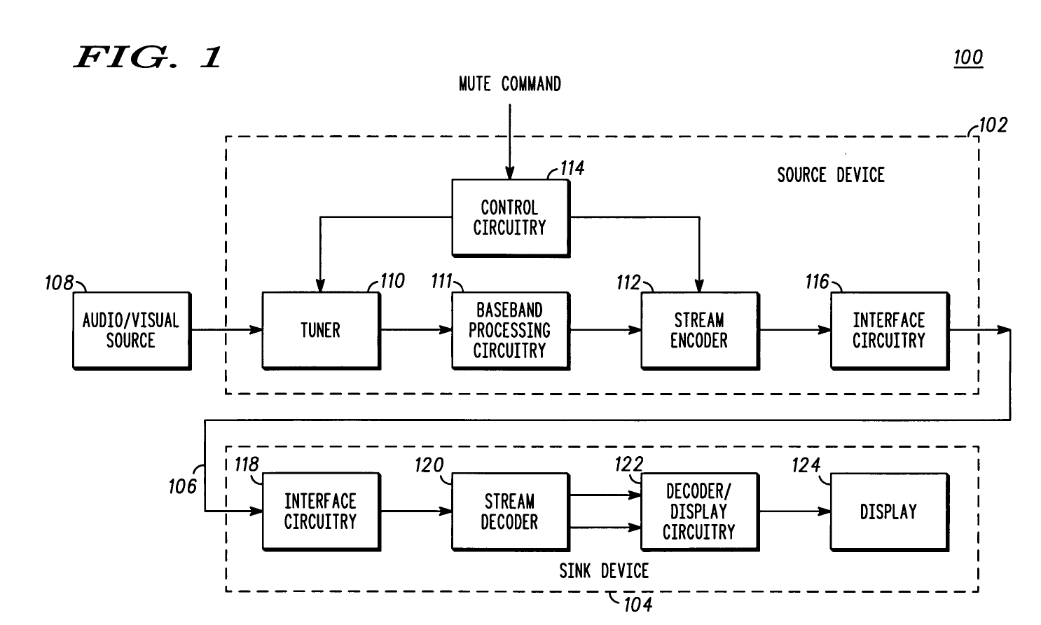

FIG. 1 is a block diagram illustrating an audio/video (AV) system (100), according to one exemplary embodiment. As illustrated in FIG. 1, the AV system (100) includes a source device (102), a sink device (104), and a digital link (106) communicatively coupling the source device to the sink device. The source device (102) is coupled to an AV source (108) configured to provide AV signals to the source device. Each AV signal received from the AV source (108) includes an AV program or service including one or more of audio, video, and data (generally referred to herein as an “AV program”). The AV source (108) may include an interface to any type of audio/video/data signal transmission source, such as land-based radio-frequency type broadcast networks, cable networks, space satellite signal transmission networks, broadband telephone networks, and the like. The transmitted AV programs received by the source device (102) may be in any type of digital transport stream format suitable for transmission purposes, such as the MPEG format, including MPEG-2 as defined in ISO/IEC Standard 13818, the digital satellite systems (DSS) format, the asynchronous transfer mode (ATM) format, and the like.

As illustrated in FIG. 1, the source device (102) includes tuner circuitry (110), baseband processing circuitry (111), a stream or transport encoder (“stream encoder (112)”), control circuitry (114), and interface circuitry (116). According to one exemplary embodiment, the source device (102) may be a set-top box (STB), a video cassette recorder (VCR), a receiver, or another like type tuning device known in the art. An input terminal of the tuner circuitry (110) is coupled to the AV source (108) for receiving AV signals. The tuner circuitry (110) selects and tunes N of the AV signals in a well known manner, where N is an integer greater than zero. For example, the tuner circuitry (110) may include dual tuners for tuning a first AV signal and a second AV signal of the AV signals provided by the AV source (108) (i.e., N=2). An output bus of the tuner circuitry (110) provides the N tuned AV signals to additional components in the source device (102).

Another input terminal of the tuner circuitry (110) is communicatively coupled to the control circuitry (114) for receiving commands there from. The control circuitry (114) controls both the selection and the number of AV signals that are tuned by the tuner circuitry (110) in response to commands from the user.

An input bus of the baseband processing circuitry (111) is communicatively coupled to the output bus of the tuner circuitry (110) for receiving the N tuned AV signals. The baseband processing circuitry (111) recovers an AV program from each of the tuned AV signals in a well known manner. The baseband processing circuitry (111) provides N recovered AV programs corresponding to the N tuned AV signals as output. As described above, the recovered AV programs may be in any known format including, but in no way limited to, known digital transport stream formats, such as those complying with the MPEG-2 systems standard.

As illustrated in FIG. 1, an input bus of the stream encoder (112) is communicatively coupled to the output bus of the baseband processing circuitry (111) for receiving the N recovered AV programs. The stream encoder (112) encodes the received AV programs to generate one or more digital transport streams as output for transmission through the interface circuitry (116), over the digital link (106), to the sink device (104). The digital transport stream(s) produced by the stream encoder (112) may be any type of digital transport or program stream(s) known in the art. For ease of explanation only, the present system and method will be described in the context of a system utilizing MPEG-2 transport streams.

Continuing with FIG. 1, a second input terminal of the stream encoder (112) is coupled to the control circuitry (114) of the source device (102). In response to a mute command from the user, the control circuitry (114) commands the stream encoder (112) to encode the AV programs in a manner establishing a command for a muting function to be performed by the sink device (104). Notably, the stream encoder (112) augments the data stream(s), corresponding to the AV programs, with control information operative to invoke muting of the audio and/or video as well as the generation of a user notification to be shown on the display (124) using only the extent functionality of the sink device (104).

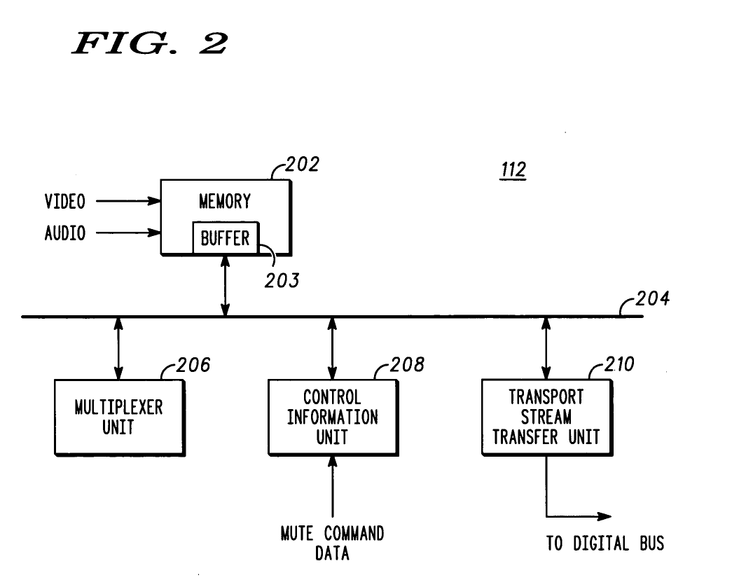

FIG. 2 illustrates an exemplary embodiment of the stream encoder (112). As illustrated in block diagram of FIG. 2, the stream encoder (112) is illustrated as receiving a single video and a single audio program. Those skilled in the art will appreciate that the stream encoder (112) may have any number of AV programs as input, such AV programs comprising video, audio, and/or data. As illustrated in FIG. 2, the stream encoder (112) includes a bus (204) coupled to a memory component (202), a multiplexer unit (206), a control information unit (208), and a transport stream transfer unit (210). An input bus of the memory (202) is communicatively configured to receive the AV programs. For example, as illustrated in FIG. 2, at least one portion of the memory component (202) may comprise a buffer (203), such as a first-in-first-out (FIFO) buffer, for buffering the data within each of the AV programs. Additionally, an output bus of the memory component (202) is communicatively coupled to the bus (204).

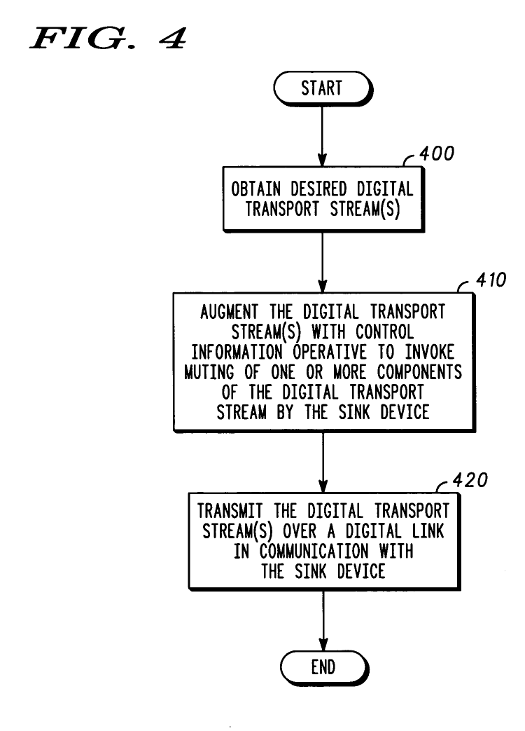

FIG. 2 also illustrates an input/output bus of the multiplexer unit (206) being communicatively coupled to the bus (204). The multiplexer unit (206) may be used to multiplex the components of the AV programs to form one or more digital transport streams. Similarly illustrated in FIG. 2, an input/output bus of the control information unit (208) is coupled to the bus (204). Another input terminal of the control information unit (208) is coupled to receive mute command data from the control circuitry (114; FIG. 1). In response to a mute command, the control information unit (208) may augment the digital transport stream(s) generated by the multiplexer unit (206) with control information in order to direct the sink device (104; FIG. 1) to perform the desired muting function. FIG. 2 further illustrates an input bus of the transport stream transfer unit (210) being communicatively coupled to the bus (204). The transport stream transfer unit (210) is configured to provide the digital transport stream(s) as output for the stream encoder (112). Embodiments of operation of the stream encoder (112) will be given below with reference to FIGS. 4 through 9.

Returning again to the AV system of FIG. 1, an input bus of the interface circuitry (116) is communicatively coupled to the output bus of the stream encoder (112) for receiving the digital transport stream(s). The interface circuitry (116) that forms a part of the source device (102) processes received digital transport streams for transmission over the digital link (106) to a sink device (104) in a well known manner. For example, according to one exemplary embodiment, the digital link (106) is an IEEE 1394 bus and the interface circuitry (116) processes the digital transport stream(s) for transmission in accordance with the IEEE 1394 protocol.

The sink device (104) illustrated in FIG. 1 is configured to receive and decode digital transport stream(s). As illustrated in FIG. 1, the present exemplary sink device (104) includes interface circuitry (118), a stream or transport decoder (“stream decoder (120)”), decoder/display circuitry (122), and a display (124). According to one exemplary embodiment, the present sink device (104) may include, but is in no way limited to, a television (e.g., high-definition television (HDTV)), a monitor, a digital projector, a VHS system, or a like type display device known in the art.

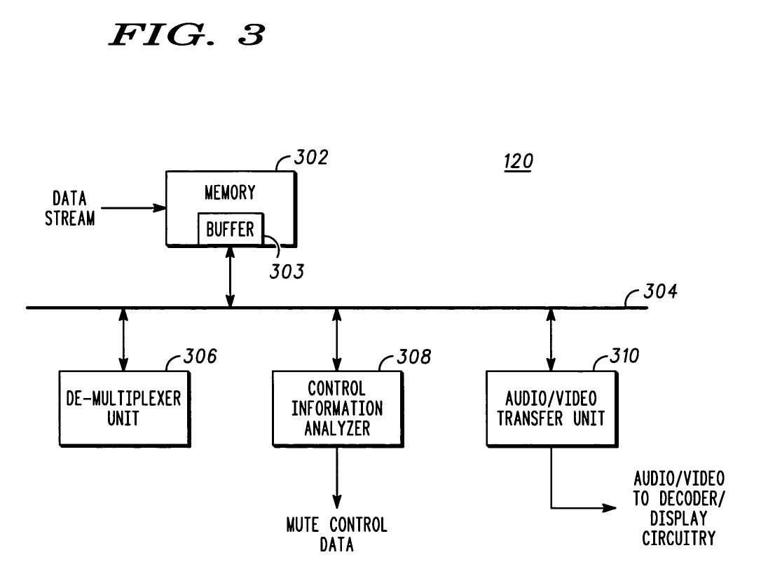

As illustrated in FIG. 1, an input bus of the interface circuitry (118) is communicatively coupled to the digital link (106) for receiving the digital transport stream(s) generated by the source device (102). The interface circuitry (118) is configured to provide the digital transport stream(s) to an input bus of the stream decoder (120). The stream decoder (120), in turn, extracts the control information within the digital transport stream(s). Notably, the stream decoder (120) uses the control information generated by the stream encoder (112) to identify an invocation of a muting function by the user and to recover the AV programs within the digital transport stream(s) for the muting function. An output bus of the stream decoder (120) provides the N recovered AV programs, as well as the control information associated with the AV programs to the decoder/display circuitry (122). A more detailed description of the stream decoder (120) is given below with reference to FIG. 3.

As illustrated in FIG. 3, the present exemplary stream decoder (120) is depicted as having a single AV program as an output. While the present exemplary stream decoder (120) is described in the context of a single AV program as an output, the stream decoder (120) may output any number of AV programs, depending on the number of AV programs transmitted within the digital transport stream(s), such AV programs comprising video, audio, and/or data. As illustrated in FIG. 3, the stream decoder (120) includes a bus (304) communicatively coupling a memory component (302), a demultiplexer unit (306), a control information analyzer (308), and an AV transfer unit (310).

As shown in FIG. 3, an input bus of the memory component (302) is configured to receive one or more digital transport streams. According to one exemplary embodiment illustrated in FIG. 3, at least a portion of the memory component (302) may include a buffer (303), such as a FIFO buffer, for buffering the data within each of the digital transport streams. An output bus of the memory component (302) is coupled to the bus (304).

An input/output bus of the control information analyzer (308) is coupled to the bus (304). The control information analyzer (308) extracts control information from the digital transport stream(s) stored within the memory (302). An input/output bus of the demultiplexer unit (306) is also coupled to the bus (304). The demultiplexer unit (306) may use the control information extracted by the control information analyzer (308) to recover the AV programs from the received digital transport stream(s). An input bus of the AV transfer unit (310) is also coupled to the bus (304). The AV transfer unit (310) is configured to provide the AV programs as output for the stream decoder (120). Exemplary embodiments of the operation of the stream decoder (120) are described in further detail below.

Returning again to the exemplary system illustrated in FIG. 1, an input bus of the decoder/display circuitry (122) is coupled to the output bus of the stream decoder (120) for receiving the control information and the N recovered AV programs. The decoder/display circuitry (122) decodes the AV data within each AV program in a well known manner. For example, if an AV program comprises compressed AV data in accordance with the MPEG standard, the decoder/display circuitry (122) comprises an MPEG decoder for decoding the audio, video, and/or data within each AV program. The decoder/display circuitry (122) uses the control information recovered by the stream decoder (120) to display the AV programs on the display (124). The display (124) may be defined by a number of audio and visual components configured to present the AV programs. As noted above, the decoder/display circuitry (122) uses the control information to vary the display of the AV programs. For example, if a mute command has been invoked by the user, the control information recovered by the stream decoder (120) is used to determine whether the audio, the video, or both are to be muted prior to presentation on the display device (124). Moreover, the recovered control information may initiate the display of feedback information on the display (124).

FIG. 4 is a flow chart illustrating an exemplary method for encoding AV programs for muting an AV component using the extant functionality of the sink device (104; FIG. 1). According to one exemplary embodiment, the exemplary method illustrated in FIG. 4 may be performed by the stream encoder (112; FIG. 2) mentioned previously. As illustrated in FIG. 4, the present exemplary method may begin by obtaining a desired digital transport stream (step 400). In one embodiment, the desired digital transport stream is generated having a plurality of AV programs. For example, a single digital transport stream is generated by multiplexing the plurality of AV programs. Alternatively, the desired digital transport stream may be recovered from received AV signals as illustrated above with reference to FIG. 1.

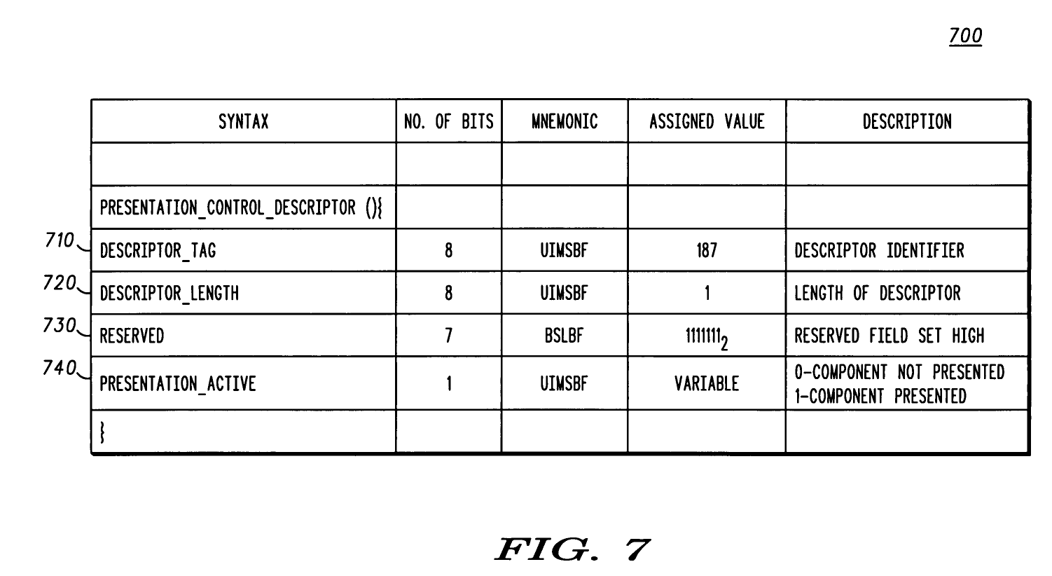

Once the desired digital transport stream(s) is obtained (step 400), the stream encoder (112; FIG. 2) augments the digital transport stream with control information operative to invoke muting of one or more components of the digital transport stream by the sink device (step 410). The control information is configured to allow a sink device (104; FIG. 1) to determine that the user has requested a muting of one or more components of the AV program. In addition, the control information allows the sink device (104; FIG. 1) to distinguish between commands requesting the muting of various components of the AV program. In one exemplary embodiment, the control information is disposed within control packets associated with a program stream within the transport stream (“program control packets”). For example, if the transport stream is an MPEG transport stream, then the control information may be disposed within a program map table (PMT). In another embodiment, the control information comprises a command that is multiplexed with the digital transport stream(s). Examples illustrating these embodiments are described below with respect to FIGS. 7 through 9. As illustrated in FIG. 4, once the digital transport streams have been augmented, the stream encoder (112; FIG. 2) transmits the digital transport stream(s) over a digital link (106; FIG. 1), such as an IEEE 1394 bus, communicatively coupled to the sink device (step 420).

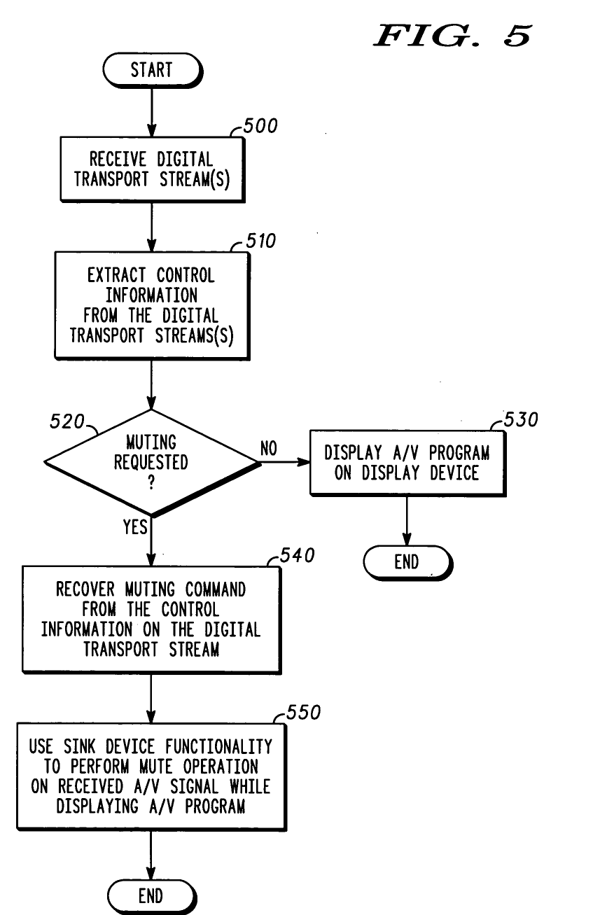

FIG. 5 is a flow chart illustrating an exemplary method for decoding one or more digital transport streams produced by the stream encoder (112; FIG. 2) as described in FIG. 4. The exemplary method or process illustrated in FIG. 5 may be performed, according to one exemplary embodiment, by the stream decoder (120; FIG. 3) that forms a part of the sink device (104; FIG. 1) described above. The exemplary method begins as one or more digital transport streams are received by the sink device (step 500). Once the transport streams have been received by the stream decoder (120; FIG. 3), the control information unit (308; FIG. 3) of the stream decoder extracts control information from the digital transport stream(s) (step 510). As described above, the control information may be disposed in particular control packets (e.g., program control packets), or may be part of a command multiplexed with the digital transport stream(s). Once the control information has been extracted from the digital transport stream (step 510), a determination is made as to whether muting of one of the AV components has been requested (step 520). If the control information indicates that no muting of the AV components has been requested (NO, step 520), the sink device (104; FIG. 1) decodes and displays the AV program on the display device without muting any of the AV components (step 530). If, however, muting of one of the AV components is requested (YES, step 520), as indicated by the control information, the muting command is recovered from the digital transport stream(s) using the control information (step 540). Once the muting commands are recovered, the extant sink device functionality is then used to perform a muting operation on the received AV signals while they are displayed (step 550). By using the extant sink device functionality to mute one or more components of the AV signal, inappropriate results may be avoided and a display feedback such as a “MUTE” display may be generated by the sink device (104; FIG. 1).

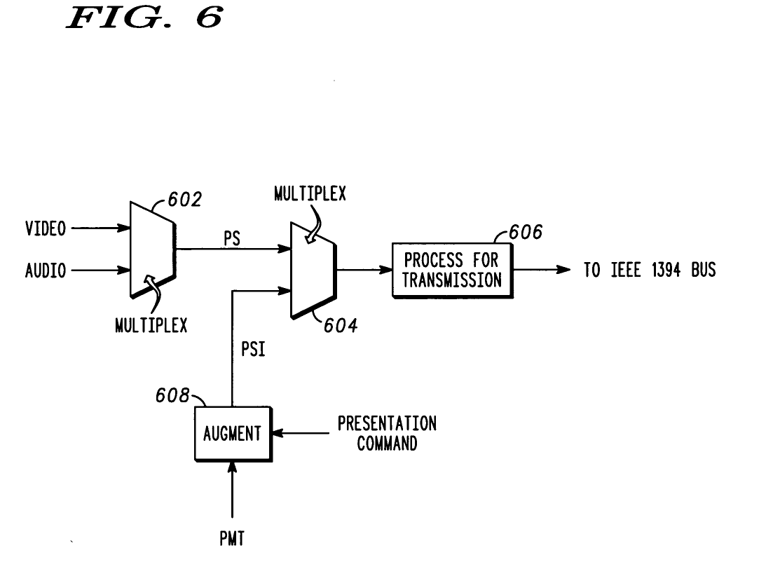

FIG. 6 is a data flow diagram depicting one exemplary method for performing the encoding process illustrated in FIG. 4. As illustrated in FIG. 6, an audio and a video component are multiplexed (602) to produce a single program stream. The program stream is multiplexed with program specific information (604) to produce an MPEG-2 transport stream. The program specific information defines control information for the transport stream. In particular, the program specific information includes a program map table associated with each service component of the program stream. The MPEG-2 transport stream is then processed for transmission over an IEEE 1394 bus (step 606).

In order for the display device to recognize and interpret audio and/or video mute commands, the program map table included in the program specific information is augmented to include one or more presentation commands (step 608). In one exemplary embodiment, the presentation command is disposed in a program level descriptor of the program map table. The presentation command may comprise packet identifiers (PIDs) associated with packets to be modified by the sink device (104). For example, the identification data may comprise a PID for video 1 and a PID for audio 1. In this manner, the display device will be able to determine an invocation of a mute operation and distinguish between different AV components within the MPEG transport stream.

FIG. 7 illustrates an exemplary presentation control descriptor (700) that may be added to the program map table for each service component in a program stream. As mentioned previously, each component of the program stream has an entry in the program map table with a descriptor that identifies whether the designated component should be presented or not. As illustrated in the exemplary embodiment of FIG. 7, the presentation control descriptor (700) includes a descriptor tag syntax (710) which is used as a descriptor identifier, a descriptor length syntax (720) which provides the length of the descriptor, and a reserved syntax (730). Additionally, a variable presentation syntax (740) is presented to notify the sink device (104; FIG. 1) whether to present or not present the identified component of the program stream.

When received by the sink device (104; FIG. 1), the stream decoder (120; FIG. 1), and more specifically the control information unit (308; FIG. 3) processes the presentation control descriptor found in the program map table. When the presentation control descriptor is processed, the stream decoder (120; FIG. 1) may determine whether or not each of the components of the program stream should be presented based on the status of the variable presentation syntax (740) of the presentation control descriptor (700). This allows the sink device (104; FIG. 4), if so directed by the presentation control descriptor (700), to identify and implement its extant muting functionality on selected AV components. Consequently, the sink device (104; FIG. 1) may perform a muting operation on the audio component, the video component, or both components of the program stream. According to one exemplary embodiment, the sink device (104; FIG. 1) is also able to provide traditional user feed back, such as a “MUTE” signal, to the user through the sink device display (124; FIG. 1).

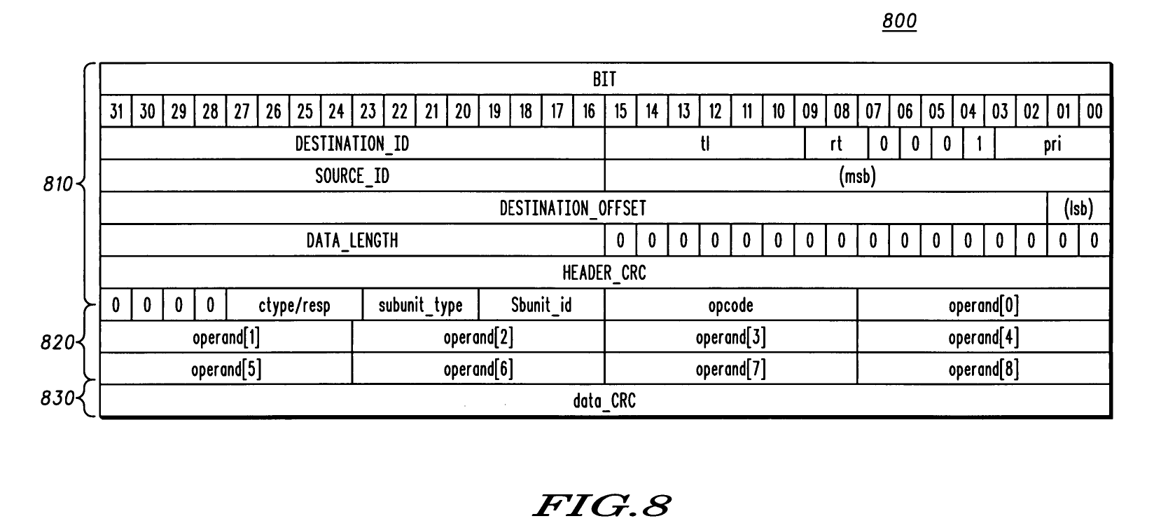

In an alternative embodiment, a new audio/visual control (AV/C) presentation command, configured to command a sink device (104; FIG. 1) to change the presentation state of an audio or a video service component, is multiplexed with in a digital transport stream. FIG. 8 is a generic structure for the presentation AV/C command (800) according to one exemplary embodiment. The 1394 Trade Association (1394TA) has defined a set of AV/C commands that are utilized by AV devices coupled by a 1394 bus. Accordingly, on a 1394 bus, the IEEE 1212 control and status register standard defines an address space that exists for the transmission of a number of designated AV/C commands. The present exemplary embodiment illustrates a new AV/C presentation command, as defined in FIG. 8, which is utilized by the source device (102; FIG. 1) to command a sink device (104; FIG. 1) to modify the presentation state of an audio and/or a video service component. According to the exemplary embodiment illustrated in FIG. 8, the AV/C presentation command (800) provides audio and video presentation settings to the sink device (104; FIG. 1) for each digital transport stream originating from the source device. According to this exemplary embodiment, the source device (102; FIG. 1) will send transport stream(s) to the sink device (104; FIG. 1) regardless of the presentation state on the source device.

Additionally, the source device (102; FIG. 1) will send the appropriate AV/C commands (800) to the sink device (104; FIG. 1) to control presentation of the transport stream content on the sink device. As mentioned previously, the memory space of the 1394 bus is based to the IEEE 1212 control and status register (CSR) architecture. Consequently, the 1394 bus appears as a large memory-mapped space with each node occupying a certain address range. This memory space is used to address specific addresses of coupled devices and transmit AV commands, such as the present AV/C presentation command (800). As illustrated in FIG. 8, the AV/C presentation command (800) includes a large section containing header information (810) followed by a number of operands (820) and a cycle redundancy check (830). While FIG. 8 illustrates one exemplary AV/C PRESENTATION format, a number of other command formats are also possible.

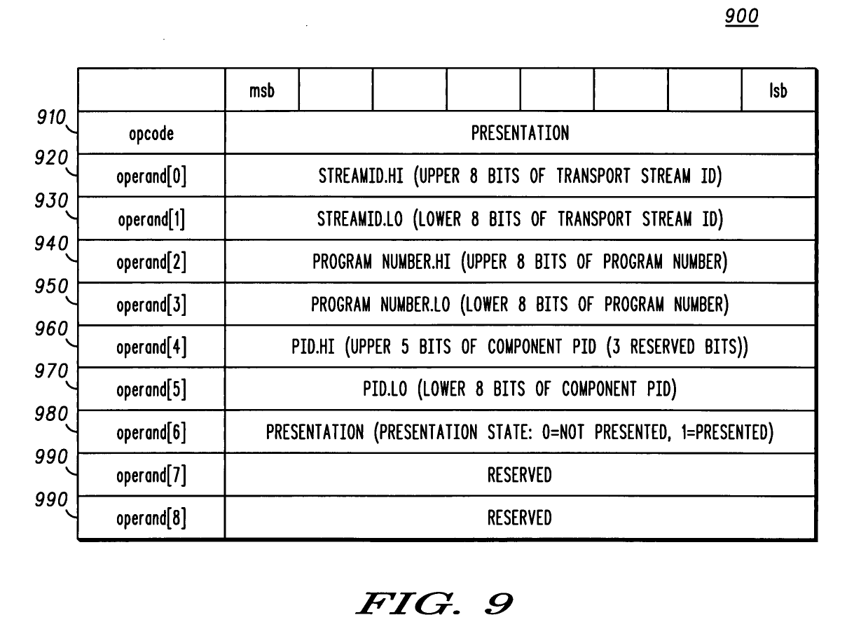

The opcode for the PRESENTATION AV/C command will be determined by the 1394 Trade Association. Source devices (102; FIG. 1) incorporating the present system and method implement a “status” version of the command which allows sink devices (104; FIG. 1) to query the presentation status. Additionally, sink devices (104; FIG. 1) would implement a status and control version of the AV/C presentation command (800) along with general inquiry to identify command support. Exemplary operands for the AV/C presentation command (800) are defined in FIG. 9. According to the present exemplary embodiment, the AV/C presentation command would provide the audio and video presentation settings for a particular component of a service on a source device transport stream. The AV/C presentation command operands identify the transport, service, and component to which the presentation setting should be applied. The Control version of the AV/C command can change the presentation setting of one component of one service on one stream. As illustrated in FIG. 9, the AV/C presentation command opcode (910) and operand definitions (900) include a first (920) and a second (930) operand that identify a transport stream identification with respect to the program association table. Similarly, a third (940) and fourth (950) operand are configured to identify a program number associated with the program association table that corresponds to the component being modified. A fifth (960) and sixth (970) operand are configured to identify a packet identifier corresponding to the component being modified. Once the transport stream, the program number, and the packet being modified are identified, the seventh operand (980) signals whether the identified component should be presented or muted. Additionally, a number of reserved operands (990) may also be present in the opcode and operand definitions.

Once the sink device (104; FIG. 1) identifies the transport stream, program number, and the packet that are being modified by the AV/C presentation command (800; FIG. 8), the sink device may perform a muting function on the identified components using extant functionality. Accordingly, an audio and/or a video component of the identified program may be muted at the sink device (104; FIG. 1) without causing a loss of signal indication at the sink device. Additionally, the sink device (104; FIG. 1) may then display any number of user informative signals to notify the user of the functionality being performed.

The command implemented by the sink device (104; FIG. 1) in response to the AV/C presentation command (800; FIG. 8), may be substantially similar to the command implemented in response to the presentation control descriptor above, with respect to FIG. 7. Notably, in one embodiment, the command comprises an operational code configured to invoke a muting function at a sink device. That is, for a particular AV program, a command indicates to the sink device which service component in a received MPEG transport stream should be muted. Any number of muting functions may be performed by the sink device (104; FIG. 1) in response to the above-mentioned commands, as programmed by the manufacturer.

According to one exemplary embodiment, the present systems and methods described above may be implemented as a computer readable carrier. Program(s) of the computer readable carrier define functions of embodiments and can be contained on a variety of signal-bearing media, which include, but are in no way limited to, information permanently stored on non-writable storage media (e.g., read-only memory devices within a computer such as CD-ROM or DVD-ROM disks readable by a CD-ROM drive or a DVD drive); alterable information stored on writable storage media (e.g., floppy disks within a diskette drive or hard-disk drive or read/writable CD or read/writable DVD); or information conveyed to a computer by a communications medium, such as through a computer or telephone network, including wireless communications. The latter embodiment specifically includes information downloaded from the Internet and other networks. Such signal-bearing media or computer readable carriers, when carrying computer-readable instructions that direct functions of the present system and method, represent embodiments of the present system and method.

In conclusion, the present systems and methods present a number of ways to mute a received MPEG transport stream using the extant capabilities of a sink device. More particularly, the present systems and methods either add a presentation control descriptor to the program map table for each service component, that directs a sink device to present or not present the service component, or incorporate a new AV/C command to command a sink device to modify the presentation state of an audio or video service component. By causing the sink device to perform the muting function, appropriate AV presentation may be preserved and accurate status indications may be readily presented to the user.

The preceding description has been presented only to illustrate and describe the present method and system. It is not intended to be exhaustive or to limit the present method and system to any precise form disclosed. Many modifications and variations are possible in light of the above teaching.

The foregoing embodiments were chosen and described in order to illustrate principles of the method and system as well as some practical applications. The preceding description enables others skilled in the art to utilize the method and system in various embodiments and with various modifications as are suited to the particular use contemplated. It is intended that the scope of the method and system be defined by the following claims.

1. A method of encoding an audio/video (AV) program for muting on a sink device comprising:
generating or recovering at least one digital transport stream having said AV program;
augmenting said at least one digital transport stream with control information, said control information being configured to invoke a muting of at least one component of said AV program by the sink device; and
transmitting said augmented digital transport stream over a digital link coupled to said sink device.

2. The method of claim 1, wherein said at least one digital transport stream comprises a single digital transport stream having a control packet associated with said AV program.

3. The method of claim 2, wherein said digital transport stream includes a program stream; and
wherein said control packet comprises a program control packet associated with said program stream.

4. The method of claim 3, wherein said digital transport stream further comprises a Motion Pictures Expert Group (MPEG) transport stream; and
wherein said program stream includes a program map table, said control information being disposed in said program map table.

5. The method of claim 1, wherein said command comprises an audio/visual control command;
said audio/visual control command including an opcode, said opcode being configured to invoke said muting of at least one component of said AV program by the sink device.

6. The method of claim 5, wherein said audio/visual control command comprises an IEEE 1212 control and status register standard compliant command.

7. The method of claim 1, wherein said digital link comprises an IEEE 1394 link.

8. A method of decoding at least one digital transport stream encoded for muting a program component on a sink device comprising:
receiving said at least one digital transport stream over a digital link coupled to a source device;
extracting control information from said at least one digital transport stream;
identifying said program component in response to said control information; and
muting said at least one program component using extant capabilities of said sink device in response to said control information.

9. The method of claim 8, wherein said control information comprises a control packet associated with said digital transport stream.

10. The method of claim 9, wherein said digital transport stream further comprises a program stream; and
wherein said control packet comprises a program control packet associated with said program stream.

11. The method of claim 10, wherein said program stream includes a program map table, said control information being disposed in said program map table.

12. The method of claim 8, wherein said control information comprises an audio/visual control command.

13. The method of claim 12, wherein said audio/visual control command includes an opcode, said opcode being configured to invoke said muting of at least one component of said AV program by the sink device.

14. The method of claim 8, wherein said muting said at least one program component using extant capabilities of said sink device in response to said control information comprises muting one of the audio, video, or data component of a program stream.

15. The method of claim 14, further comprising displaying a status indication on said sink device using extant display capabilities of said sink device.

16. An encoder for encoding an audio/video (AV) program to be selectively muted on a display device comprising:
a multiplexer unit configured to generate at least one digital transport stream from said AV program; and
a control information unit configured to augment said at least one digital transport stream with control information, said control information operative to invoke a selective muting of one or more components of said AV program on the display device using extant muting capabilities of the display device.

17. The encoder of claim 16, further comprising interface circuitry;
said interface circuitry being configured to transmit said at least one augmented digital transport stream over a digital link communicatively coupling said encoder and said display device.

18. The encoder of claim 17, wherein said digital link comprises an IEEE 1394 bus.

19. A decoder for decoding at least one augmented digital transport stream having at least one audio/visual (AV) program and control information being configured to invoke a muting of at least one component of said AV program by a display device comprising:
a control information analyzer configured to extract said control information from said digital transport stream; and
a demultiplexing unit configured to recover said AV program within said digital transport stream.

20. The decoder of claim 19, further comprising interface circuitry;
said interface circuitry being configured to receive said augmented digital transport stream over a digital link communicatively coupling said decoder to a source device.

21. The decoder of claim 20, wherein said digital link comprises an IEEE 1394 bus.

22. A processor readable medium having instructions thereon for encoding an audio/video (AV) program for muting on a sink device, said instructions being configured to instruct an encoder to perform the method of:
generating or recovering at least one digital transport stream having said AV program;
augmenting said at least one digital transport stream with control information, said control information being configured to invoke a muting of at least one component of said AV program by the sink device; and
transmitting said augmented digital transport stream over a digital link coupled to said sink device.

23. The processor readable medium of claim 22, wherein said processor readable medium is disposed on a source device.

24. The processor readable medium of claim 23, wherein said source device comprises one of a set-top box (STB), a video cassette recorder (VCR), or a receiver.

25. A processor readable medium having instructions thereon for decoding at least one digital transport stream encoded for muting a program component on a sink device, said instructions being configured to instruct an encoder to perform the method of:
receiving said at least one digital transport stream over a digital link coupled to a source device;
extracting control information from said at least one digital transport stream;
identifying said program component in response to said control information; and
muting said at least one program component using extant capabilities of said sink device in response to said control information.

26. The processor readable medium of claim 25, wherein said processor readable medium is disposed on a sink device.

27. The processor readable medium of claim 26, wherein said sink device comprises one of a projector, a high-definition television, or a digital video home system (VHS).
